(19) United States
(12) Patent Application Publication
(10) Pub. No.: US 2024/0146674 A1
(43) Pub. Date: May 2, 2024

(54) COMPUTER-IMPLEMENTED METHOD FOR SENDING ELECTRONIC VOICE MESSAGES BY E-MAIL

(71) Applicant: Karin LANG, Stubenberg (DE)

(72) Inventor: Karin LANG, Stubenberg (DE)

(21) Appl. No.: 18/083,353

(22) Filed: Dec. 16, 2022

(30) Foreign Application Priority Data
Oct. 27, 2022 (DE) 102022128521.9

(51) Int. Cl. H04L 51/07; H04M 3/53

(52) U.S. Cl. CPC H04L 51/07; H04M 3/5307

(57) ABSTRACT

A computer-implemented method for sending electronic voice messages by e-mail by means of an e-mail program includes the steps of starting up a recording system for recording a voice message, recording the voice message by means of the recording system, listening to and thus reproducing the voice message, and sending the voice message by means of at least one remote communication means and is characterized in that a recording of the voice message is recorded by means of at least one recording button which can be controlled in a user interface of the recording system, the recording system being different from an instant messenger system.

The present invention concerns a computer-implemented method for sending electronic voice messages by e-mail according to the generic terms of claims 1 and 9.

The inventor has recognized the problem that sending a voice message, especially in com-mon file formats such as dcc, is cumbersome. In the past, a dictation machine had to be inserted into a docking station provided for this purpose, the voice file then had to be inserted into the mail message to be sent, for example using the Windows system “Outlook”, and only then could the new mail be sent together with the voice file as a file attachment. With i talk24, for example, it is necessary to first manually insert a link with the voice message into the e-mail.

The task of the present invention is therefore to eliminate the above-mentioned problem and therefore to offer a method for sending electronic voice messages on the basis of an e-mail program which makes it possible to send voice messages in digital form in a particularly simple manner. The voice messages are sent by means of a recording button on the basis of an e-mail program through the commissioning, recording, listening and sending on the technology of smart contracts, tokens, proxy and DLT, whereby the recording button is thereby programmable by means of speech recognition.

In a first step, the method according to the invention for sending electronic voice messages by e-mail comprises the commissioning of a recording system for recording a voice message.

In a further step, the voice message is recorded by means of the recording system. In a sub-sequent step, the voice message is sent by at least one means of remote communication.

According to the invention, the computer-implemented method for sending electronic voice messages by e-mail comprises starting up a recording system for recording a voice message, recording the voice message by means of the recording system, listening to and thus reproducing the voice message, and sending the voice message by means of at least one remote communication means, wherein a recording of the voice message is recorded by means of at least one recording button which can be controlled in a control interface of the recording system, whereby the recording system is different from an instant messenger system.

According to at least one embodiment, the computer-implemented method further comprises a processor and a computer-readable storage medium on which a program code is stored or else deposited on a decentralized storage system, which, when executed by the processor, causes the processor. Also, the method comprises receiving and sending the voice message, which may be an attachment to an e-mail, on the basis of smart contracts, wherein the voice message is priced into the decentralized smart contract system in digitally modulated form, wherein the voice message is a summary of individual digital metrics, wherein on the basis of smart contracts these metrics are traded within the smart contract system, namely inter alia in so far as the key figures cause the smart contract system to generate a part, one or more tokens, and further wherein this token is traded within the decentralized smart contract system, and the acquirer therefore receives at least one key figure, preferably all key figures, of the voice message, and on the basis of the key figures the voice message is then at least partially reconstructed, and for this purpose together with one or more key figures a decomposition and/or construction key of the voice message is also acquired.

According to at least one embodiment, the summary of key figures is an overview and/or key figure that is cumulative or summarized by some other arithmetic operation.

According to at least one embodiment, the index number is a real number greater than zero or is a complex number.

According to at least one embodiment, a program code causes a processor to generate the token or the identification code stored in the program code of the token causes the processor to generate the instantiation of a token object based on the selected token template, wherein the token object includes standard logic for each of the one or more control functions inherited from the selected token template.

According to at least one embodiment, the program code that causes the processor to generate the token further comprises program code that causes the processor to route the token object to a proxy specific to a distributed ledger technology (DLT) used by the distributed ledger network and to establish, via the proxy, a transaction based on one or more rules of the DLT; and to send, via the proxy, the transaction to the distributed ledger network.

According to at least one embodiment, the computer-readable storage medium further comprises program code that causes the processor to do the following, thereby causing the processor to receive a control message corresponding to a control function included in the token (201) and to execute the control function and generate a function result, routing the function result to a proxy specific to a DLT used by the distributed ledger network establishing, via the proxy, a transaction based on one or more rules of the DLT, and sending, via the proxy, the transaction to the distributed ledger network.

According to at least one embodiment, setting up the transaction includes retrieving a cryptographic key associated with the user and the distributed ledger network and digitally signing the transaction using the cryptographic key.

According to at least one embodiment, the computer-readable storage medium further comprises program code for causing the processor to receive, from the user, a request to import an existing token, the request to import including an address of the existing token in the distributed ledger network, and to verify an implementation of the token, as stored at the address, determining an asset type for the existing token, identifying a token template or tokens in the one or more token templates or tokens corresponding to the determined asset type, and generating another token on the distributed ledger network based on the identified token template and the existing token.

According to at least one embodiment, the recording of the voice message is recorded by means of at least one recording button controllable in a user interface of the recording system, wherein the recording system is different from an instant messenger system.

The record button therefore serves as an integrated graphical user interface element which appears, for example, in a toolbar of the mail sending program. A time-consuming conversion and/or moving of the voice message from one data carrier (for example, from a dictation machine) to another data carrier (computer hard disk, SSD, etc.) can therefore be dispensed with. This leads to a highly simplified method for sending voice messages by means of a remote communication medium. A remote communication medium can be a WLAN router or a mobile network.

According to at least one embodiment of the method, the method comprises a first step, according to which a recording system for recording a voice message is put into operation. In a second step, a voice message is recorded by means of the recording system. In a further step, the voice message is sent by means of at least one remote communication means. In a further step, the one recording of the voice message is recorded by means of at least one recording button controllable in a user interface of the recording system, wherein the recording system is different from an instant messenger system.

Also, the present method may utilize one or more method steps relating to the property of an artificial intelligence, including as follows.

Artificial intelligence (“AI”) as a scientific discipline is only a few decades old and thus significantly younger than the classical natural sciences. Nevertheless, it rightly claims the rank of a scientific sector in its own right. Its subject exerts a special fascination. The reason for this may be that abstract thinking, creativity and even more so consciousness are widely regarded as generically human abilities. The fact that AI systems seem to be increasingly acquiring these abilities, or at least imitating them, and may soon surpass humans in this respect, is no less drastic as a paradigm shift than the discovery of the heliocentric view of the world or of biological evolution. AI is also playing an increasingly important role in technological advancement, and there is nothing to suggest that this trend should end in the foreseeable future.

The decisive factor for access to patent protection is the technicality of an invention. It is not obvious whether inventions such as a computer program for machine translation or word processing, for image recognition on satellite images, a computer-based medical diagnosis system or a teaching tutorial for learning a foreign language, a legal tech or autonomous driving system, speech recognition software or a chess computer are to be considered technical or not. Nevertheless, the distinction between technical and non-technical inventions, developed in its details by case law, has a function of central importance for the promotion of in-novation by patents also for the new and dynamic sector of AI:

Artificial intelligence and machine learning are based on computational models and algorithms for classification, clustering, regression and dimensionality reduction such as neural networks, genetic algorithms, support vector machines, k-means, kernel regression and discriminant analysis. Such computational models and algorithms are per se of abstract mathematical nature, regardless of whether they can be “trained” using training data. Therefore, the guidelines in G II, 3.3 generally apply to such computational models and algorithms as well.

Expressions such as “support vector machine,” “reasoning engine,” or “neural network” may refer only to abstract models or algorithms, depending on the context, and therefore do not in themselves necessarily imply the use of technical means.

Artificial intelligence and machine learning are finding application in various fields of technology. For example, the use of a neural network in a heart monitoring device to identify irregular heartbeats makes a technical contribution. Classification of digital images, videos, audio and speech signals based on low-level features (e.g., edges or pixel attributes for images) is another typical technical application of classification algorithms.

When a classification method serves a technical purpose, the steps of “generating the training dataset” and “training the classifier” may also contribute to the technical nature of the invention if they support the achievement of that technical purpose.

In this respect, it is conceivable that the exception system recognizes the user on the basis of a user ID, in particular on the basis of the IP address or a user account, and infers a future behavior on the basis of a behavior selected in the past or automatically recognized by the system. The behavioral pattern can be a size (in bits) of the voice message size selected in the past in time, arithmetic or other average value, so that already before the voice message has started the recording system reserves a memory location for the voice message to be created.

According to at least one embodiment, the recording system is part of an e-mail sending program, or forms an e-mail sending program itself. The mail dispatch program can be a part of the mail system “Outlook”. For this purpose, a code of the sending program may be modified accordingly so that the button for recording the voice message is displayed in a window of the user interface. The voice message itself can be stored on a hard disk, SSD or other memory.

According to at least one further embodiment, a user interface of the e-mail sending program displays the record button in a position provided for this purpose.

According to at least one embodiment, the voice message can also be sent without a text message, preferably by pressing a send button or by means of a voice command, such as “send”.

According to at least one further embodiment, the recording system automatically detects a start and/or an end of the recording process of the voice message without actuating a recording button. For this purpose, a microphone of the recording system can be connected to a speech recognition system.

According to at least one embodiment, after a completion of recording of the voice message detected by the recording system, the voice message is sent by the recording system.

According to at least one embodiment, the voice message is created as an email attachment by the recording system.

Further, the present invention comprises an apparatus for sending electronic voice messages, the apparatus comprising at least one recording system for recording a voice message and at least one remote communication means for sending the voice message by means of at least one remote communication means.

According to at least one embodiment, the recording system is arranged and provided for recording the voice message by means of at least one recording button controllable in a user interface of the recording system, wherein the recording system is different from an instant messenger system.

In the following, the invention described here is described in more detail with reference to an example of an embodiment and the associated figure. Components acting in the same way or in the same manner are provided with the same reference signs.

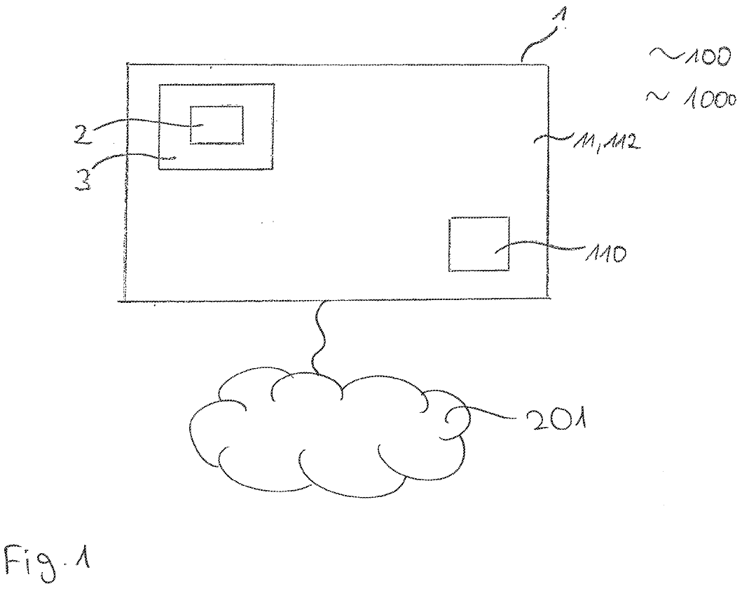

FIG. 1 shows that the computer-implemented method 1000 for sending electronic voice messages 2 by e-mail comprises starting up a recording system 1 for recording a voice message 2, recording the voice message 2 by means of the recording system 1, listening to and thus reproducing the voice message 2, and sending the voice message 2 by means of at least one remote communication medium, listening to and thus reproducing the voice message 2, and sending the voice message 2 by means of at least one remote communication means, wherein a recording of the voice message 2 is recorded by means of at least one recording button 110 controllable in a user interface 11 of the recording system 1, wherein the recording system 1 is different from an instant messenger system. The computer-implemented method 1000 further comprises a processor and a computer-readable storage medium on which a program code is stored or else deposited on a decentralized storage system that, when executed by the processor, causes the processor. Also, the method 1000 comprises receiving and sending the voice message 2, which may be in the form of an attachment to an email, on a smart contract basis, wherein the voice message 2 is priced into the decentralized smart contract system in a digitally modulated form, wherein the voice message 2 is an aggregation of individual digital metrics, wherein on a smart contract basis these metrics are traded within the smart contract system, namely, inter alia, in that the metrics cause the smart contract system to generate a part, one or more tokens 201, and further wherein this token 201 is traded within the decentralized smart contract system, and the acquirer therefore receives at least one key figure, preferably all key figures, of the voice message 2, and on the basis of the key figures the voice message 2 is then at least partially recovered, and for this purpose together with one or more key figures a decomposition and/or construction key of the voice message 2 is also acquired.

The summary of key figures is an overview and/or key figure that is cumulated or summarized by another arithmetic operation.

The key figure is a real number greater than zero or a complex number.

Ein Programmcode bewirkt also, dass ein Prozessor das Token 201 erzeugt oder die im Programmcode des Tokens 201 hinterlegte Kennzahl bewirkt, dass der Prozessor das Instanziieren eines Token-Objekts basierend auf der ausgewahlten Token-Vorlage erzeugt, wobei das Token-Objekt Standardlogik für jede der einen oder mehreren Steuerfunktionen enthalt, die von der ausgewahlten Token-Vorlage vererbt werden.

The program code that causes the processor to generate the token 201 further comprises a program code that causes the processor to route the token object to a proxy specific to a distributed ledger technology (DLT) used by the distributed ledger network and to establish, via the proxy, a transaction based on one or more rules of the DLT; and to send, via the proxy, the transaction to the distributed ledger network.

Building the transaction involves retrieving a cryptographic key associated with the user and the distributed ledger network and digitally signing the transaction using the cryptographic key.

The computer-readable storage medium further comprises program code for causing the processor to receive, from the user, a request to import an existing token 201, the request to import including an address of the existing token 201 in the distributed ledger network and verifying an implementation of the token 201, as stored at the address, determining an asset type for the existing token 201, identifying a token template or tokens in the one or more token templates or tokens 201 that corresponds to the determined asset type, and generating another token 201 on the distributed ledger network based on the identified token template and the existing token 201.

FIG. 1 shows an embodiment of a method 1000 according to the invention and an apparatus 100 according to the invention for operating a method 1000 for sending electronic voice messages 2.

As can be seen from FIG. 1, an example of a method 1000 for sending electronic voice messages 2 is shown there, which comprises in a first step the commissioning of a recording system 1 for recording a voice message 2, in a further step the voice message 2 is recorded by means of the recording system 1 and in a third step the voice message 2 is sent by means of at least one remote communication medium. The recording of the voice message 2 is carried out by means of at least one recording button 110 that can be controlled in a user interface 11 of the recording system 1, whereby the recording system 1 is different from an instant messenger system.

Further, FIG. 1 shows that the recording system 1 is tel of an email sending program or forms an email sending program itself, wherein a user interface 112 of the email sending program displays the recording button 110 in a position provided therefor.

As can further be seen from FIG. 1, the voice message 2 is sent, for example, together with a text message 3, preferably by actuating a send button, wherein the recording system 1 automatically and therefore without actuating a recording button 110 detects a start and/or an end of the recording process of the voice message 2 and after a termination of the recording of the voice message 2 detected by the recording system 1, the voice message 2 is sent by the recording system 1, wherein the voice message 2 is created as an e-mail attachment by the recording system 1.

Also shown in FIG. 1 is a device 100 for sending electronic voice messages, which comprises at least one recording system 1 for recording a voice message 2 and at least one remote communication means 3 for sending the voice message 2 by means of at least one remote communication means 3. It can be seen that the device 100 for sending electronic voice messages is characterized in that the recording system 1 is arranged and provided for recording the voice message 2 by means of at least one recording button 110 controllable in a user interface 11 of the recording system 1, wherein the recording system 1 is different from an instant messenger system.

The invention is not limited by the description based on the embodiment example. Rather, the invention encompasses any new feature, as well as any combination of features, which in particular includes any combination of features in the patent claims, even if this feature or combination itself is not explicitly stated in the patent claims or in the embodiment example.

### LIST OF REFERENCE SIGNS

1 Recording system
2 voice message
3 text message
11 control interface
100 device
110 recording button
112 user interface
113 Procedure

1. Computer-implemented method (1000) for sending electronic voice messages (2) by e-mail comprising the steps of:
Commissioning of a recording system (1) for recording a voice message (2),
Recording the voice message (2) using the recording system (1),
For example, listening to and thus reproducing the voice message (2),
Sending the voice message (2) by means of at least one means of remote communication,
wherein a recording of the voice message (2) is recorded by means of at least one recording button (110) which can be controlled in an control surface (11) of the recording system (1), wherein the recording system (1) is different from an instant messenger system.

2. Computer-implemented method (1000) for sending electronic voice messages (2) according to claim 1, comprising:
a processor and a computer-readable storage medium on which program code is stored or else deposited on a distributed storage system that, when executed by the processor, causes the processor:
receiving and sending the voice message (2), which may be an attachment to an e-mail, on the basis of smart contracts, wherein the voice message (2) is priced into the decentralized smart contract system in digitally modulated form, wherein the voice message (2) is a summary of individual digital metrics, wherein on the basis of smart contracts these metrics are traded within the smart contract system, namely inter alia in that the metrics cause the smart contract system to generate a part, one or more tokens (201), and further wherein
this token (201) is traded within the decentralized smart contract system, and the acquirer therefore receives at least one key figure, preferably all key figures, of the voice message (2), and on the basis of the key figures the voice message (2) is then at least partially restored, and for this purpose together with one or more key figures a decomposition and/or construction key of the voice message (2) is also acquired.

3. Computer-implemented method (1000) according to claim 1,
wherein the summary of key figures is an overview and/or key figure that has been cumulated or summarized by some other arithmetic operation.

4. Computer-implemented method (1000) according to claim 1,
wherein the key figure is a real number greater than zero or it is a complex number.

5. Computer-implemented method (1000) according to claim 1,
wherein a program code causes a processor to generate the token (201) or the identification number stored in the program code of the token (201) causes the processor:
Instantiate a token object based on the selected token template, wherein the token object includes default logic for each of the one or more control functions inherited from the selected token template.

6. Computer-implemented method (1000) according to claim 1,
wherein the program code that causes the processor to generate the token (201) further comprises program code that causes the processor to:
Routing the token object to a proxy specific to a distributed ledger technology (DLT) used by the distributed ledger network;
Constructs, via the proxy, a transaction based on one or more rules of the DLT; and
Sending, via the proxy, the transaction to the distributed ledger network.

7. Computer-implemented method (1000) according to claim 1,
wherein the computer-readable storage medium further comprises program code that causes the processor to:
Execute the control function and generate a function result;
Route the function result to a proxy specific to a DLT used by the distributed ledger network;
Establishing, via the proxy, a transaction based on one or more rules of the DLT; and
Sending, via the proxy, the transaction to the distributed ledger network.

8. Computer-implemented method (1000) according to claim 1,
wherein the building of the transaction includes:
Retrieving a cryptographic key associated with the user and the distributed ledger network; and
digitally signing the transaction using the cryptographic key.

9. Computer-implemented method (1000) according to claim 1,
wherein the computer-readable storage medium further comprises program code that causes the processor to:
Receiving, from the user, a request to import an existing token (201), the request to import including an address of the existing token (201) in the distributed ledger network;
Verifying an implementation of the token (201) as stored at the address;
Determining an asset type for the existing token (201);
Identifying a token template or token (201) in the one or more token templates or tokens (201) that corresponds to the particular asset type; and
Generating another token (202) on the distributed ledger network based on the identified token template and the existing token (201).
